(19) United States
(12) Patent Application Publication
(10) Pub. No.: US 2021/0355414 A1
(43) Pub. Date: Nov. 18, 2021

(54) GRIME DETECTION CLEANERS USING DYES

(71) Applicant: CAO Group, Inc., West Jordan, UT (US)

(72) Inventor: Steven D. Jensen, South Jordan, UT (US)

(21) Appl. No.: 17/317,709

(22) Filed: May 11, 2021

Related U.S. Application Data
(60) Provisional application No. 63/025,030, filed on May 14, 2020.

(51) Int. Cl. C11D 3/40; C11D 11/00; B08B 7/00

(52) U.S. Cl. CPC C11D 3/40; B08B 7/0057; C11D 11/0041

(57) ABSTRACT

A cleanser with improved latent grime detection may feature a dye combined with an active cleaning agent. The dye may be UV reflective or may be visibly seen by the naked eye. The cleanser may be applied in any conventional or later discovered method, including direct spray, flooding, or a saturated towelette. Use is contemplated primarily in medical and dental fields, but the cleansers may be utilized in any environment where hard surfaces require periodic cleansing.

### CROSS-REFERENCES TO RELATED APPLICATIONS

The present invention claims priority as a non-provisional perfection of prior filed U.S. Application No. 63/025,030, filed on May 14, 2021, and incorporates the same by reference herein in its entirety.

### FIELD OF THE INVENTION

The present invention relates to the field of cleaning products and more particularly relates to a cleaning product for household, industrial, medical, or laboratory use which stains grime with a dye for easier detection after initial cleaning.

### BACKGROUND OF THE INVENTION

No matter how clean an area one tries to maintain, dirt, grime, and other contaminants inevitably pollute the area. This causes a never-ending cycle of cleaning, the frequency and militancy of that cycle being determined by the need, or at least perceived want, of keeping that area clean to a given standard. Different areas require different levels of cleanliness. Certain laboratories need to be constantly monitored for contaminants while some household surfaces may just need cleaned periodically for dust, like a display shelf, or cleaned a couple times a day, like a kitchen counter. In any event, since cleaning is usually done by humans, there is always the possibility of not reaching the desired level of cleanliness despite initial efforts. Unfortunately, there is no way to quickly determine the cleanliness of certain surfaces, particularly if the dirt and grime are closely match the color of the surface or are in minute but still significant amounts.

The present invention utilizes dyes that fluoresce under a specific wavelength of radiant energy, these are added to surface cleansers that are designed to be applied to surfaces that require routine cleaning, especially in the medical and dental fields. These dyes absorb more readily into grime than the hard surfacing of contemporary counter-tops or other hard surfaces and thereby provides a means to identify contaminated areas that have yet to be wiped clean with a UV or other light source. Exposure to a specific light source allows the professional to quickly determine if a surface has been wiped down completely and detect areas that are still contaminated. The present invention represents a departure from the prior art in that the cleansers of the present invention allow for a detection function for remaining grime and other contaminants not present in the prior art.

### SUMMARY OF THE INVENTION

In view of the foregoing disadvantages inherent in the known types of cleansers an improved cleanser may provide a grime-staining cleanser that meets the following objectives: that it provides a dye with which to stain all grime to which it is exposed and that any grime that is left after initial cleansing will then be more easily detectable by the user. As such, a new and improved cleansers may comprise a cleanser imbued with UV or other dyes to accomplish these objectives.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### DETAILED DESCRIPTION OF THE PREFERRED EMBODIMENT

With reference now to the drawings, a preferred embodiment of the grime detection cleansers is herein described. It should be noted that the articles “a”, “an”, and “the”, as used in this specification, include plural referents unless the content clearly dictates otherwise.

An embodiment of the present invention utilizes UV dyes that are essentially colorless under ambient light and become visible when exposed to UV light; these are commonly known as optical brighteners. The present invention utilizes stilbenes and other UV compounds as UV dyes these include but are not limited to: 4,4′diamino 2,2′-stilbenedisulfonic acid, 2,5-bis(benzoxazol-2-yl)thiophene, 4,4′-bis(benzoxazolyl)-cis-stilbene, 7-hydroxycoumarin and any other useful UV dye.

An embodiment of the present invention utilizes dyes that bind to the organic and biological compounds that might be contaminants found in common grime. These dyes are intended to permanently stain contaminated areas until the grime is physically removed by additional cleaning. The preferred dyes that bind to organic and biological compounds are those that have essentially little color under ambient light and become visible under exposure to a specific wavelength of light. Dyes that bind to organic and biological compounds that are visible under what is usually considered ambient light are also within the scope of this Specification but are less preferred as the stain is permanently visible until physically removed by cleaning. These dyes include but are not limited to: Fluorescein isothiocyanate, Tetramethylrhodamine isothiocyanate, Bis-benzimides, propidium iodide, acridine orange, tetramethyl rosamine, rhodamine, 1-Anilinonaphthalene-8-sulfonic acid, and any other organic or biological binding dye.

An embodiment of the present invention incorporates dyes together with cleansing agents to produce a grime detection cleanser all-in-one. The preferred dyes are those that are soluble in the desired cleanser such that they are uniformly dispersed when applied to a surface. The cleanser can be applied by various means such as direct spray, flooding, a saturated towelette, and any other various means of surface application. The end-user simply applies the cleanser to the surface and then wipes it dry with an absorbent towel; thereafter the area can be inspected for thoroughness by radiating the area with a specific wavelength of light that makes the residual dye on the surface visible to the human eye and alerts the end-user if additional cleaning is required.

Another embodiment of the present invention incorporates the grime detection and cleansing function in a three-part system. A first part comprises a fast-drying dye detection liquid that is first applied to a desired cleaning surface, thereafter the second part of the system has the surface wiped clean using contemporary surface cleansers and absorbent towels. Finally, the area is radiated with a specific wavelength of light that exposes any residual dye left on the surface and alerts the end-user if additional cleaning is required.

The preferred use of the grime detecting cleansers is in the medical and dental fields; but they may be used in other environments, including but not limited to laboratories, households, corporate and business environments, schools, dormitories, restaurants, cafeterias, or any environment where cleanliness of hard, non-porous surfaces is desired. Use of these cleansers not only is effective as a spot check for cleanliness inspections, but also as a training aid to help new employees, or even children at home, to learn to properly clean a surface.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A cleanser for cleaning a surface comprising:
an active cleansing agent; and
a dye capable of binding with grime which may be present on the surface;
wherein the dye binds with and stains the grime thereby aiding in the detection of any grime remaining on the surface after initial cleansing of said surface.

2. The cleanser for cleaning a surface of claim 1, in combination with a UV light source being used to illuminate remaining stained grime on the surface.

3. The cleanser for cleaning a surface of claim 2, the dye being selected from the set of dyes consisting of: 4,4′diamino 2,2′-stilbenedisulfonic acid, 2,5-bis(benzoxazol-2-yl)thiophene, 4,4′-bis(benzoxazolyl)-cis-stilbene, and 7-hydroxycoumarin.

4. The cleanser for cleaning a surface of claim 1, the dye being selected from the set of dyes consisting of: Fluorescein isothiocyanate, Tetramethylrhodamine isothiocyanate, Bis-benzimides, propidium iodide, acridine orange, tetramethyl rosamine, rhodamine, and 1-Anilinonaphthalene-8-sulfonic acid.

5. The cleanser for cleaning a surface of claim 1, the cleanser being administered by a means selected from the set of means for administering a cleanser consisting of: a direct spray, flooding, and a saturated towelette.

6. A method of cleaning a surface, the method comprising:
a first step of applying a fast-acting dye compound to the surface;
a second step of cleaning the surface; and
a third step of irradiating the surface with a given wavelength of light which the dye will reflect;
wherein any areas left uncleaned will still be imbued with the dye and reflect the light, indicating an area that is insufficiently cleaned.

7. The method of claim 5, the dye being UV reflective and the wavelength of light being ultraviolet.

8. The method of claim 5, the dye compound being capable of reflecting a wavelength of light commonly found in ambient light.
